(19) United States
(12) Patent Application Publication
(10) Pub. No.: US 2016/0287002 A1
(43) Pub. Date: Oct. 6, 2016

(54) DEVICE FOR PREPARING A CHILLED INFUSED BEVERAGE

(71) Applicant: CONOPCO, INC., d/b/a UNILEVER, Englewood Clifffs, NJ (US)

(72) Inventors: Tim VAN BREUGEL, 1111 ZC Diemen (NL); Robert Wim BRONWASSER, 1031 KB Amsterdam (NL); Bartholomeus Johannes Antonius van HAPEREN, 3036 KC Rotterdam (NL); Ian SMITH, Sharnbrook (GB)

(73) Assignee: Conopco, Inc., d/b/a UNILEVER, Englewood Cliffs, NJ (US)

(21) Appl. No.: 15/034,412

(22) PCT Filed: Nov. 3, 2014
(86) PCT No.: PCT/EP2014/073536

§ 371 Date: May 4, 2016

(30) Foreign Application Priority Data
Nov. 8, 2013 (EP) 13192164.5

(51) Int. Cl. A47J 31/06; A23F 3/18; A47J 31/02

(52) U.S. Cl. CPC A47J 31/0615; A47J 31/02; A23F 3/18

(57) ABSTRACT

The present invention relates to a device for preparing a chilled, infused beverage, preferably iced tea, in a fast and uncomplicated manner and with constant quality. The device comprises a brewing chamber (1), wherein an opening (3) is present in the brewing chamber to allow discharge of water from the brewing chamber, and wherein the opening (3) allows the brewing chamber (1) when full of water to empty by gravity in a fixed time of between 0.5 and 1.5 minute.

The present invention relates to a device for preparing an infused chilled beverage.

The invention further relates to a process to prepare an infused chilled beverage. Furthermore, the invention relates to the use of the device of the present invention for preparing an infused chilled beverage.

### BACKGROUND OF THE INVENTION

Iced tea is generally available in bottles and packs. This is generally prepared by brewing tea, cooling it and optionally adding flavours and/or sugar. “Brewing” is commonly referred to as “infusing” in the field. The consumer can freshly prepare iced tea at home. This is traditionally done by preparing a hot tea and cooling it by pouring the resulting brewed, hot tea over ice cubes or leaving it in the fridge to allow cooling. Such a process involves various steps, equipment and planning to obtain the desired end result. Especially in a restaurant setting, this is not desired. Both for the waiter and for the consumer this process is considered too elaborate and time consuming. Preparing a larger batch of iced tea to serve several customers over a longer period of time is not desired, as the iced tea resulting from this process is easily associated with old tea. The resulting beverage may easily vary in quality, depending on the time of preparation and the time between preparation and serving, or may easily perceived as lower in quality by the consumer, compared to a beverage based on a freshly brewed tea. A further disadvantage is that iced tea prepared in bulk limits the amount of variants that can be offered, for practical reasons.

Devices for use at home have been described to brew hot tea. Examples are WO10097011A1, CN200980584, US2004/0194632A1, U.S. Pat. No. 6,494,128, U.S. Pat. No.57,585,765, U.S. Pat. No.5,632,194, and U.S. Pat. No.5,855,160. These devices share the principle that a tea is brewed in a brewing chamber. The brewing process takes a certain amount of time. Mechanical systems are incorporated in the devices, which automatically or manually open the brewing chamber at the end of the brewing process. The tea then runs into a collection container and is ready to drink. These devices are not designed in a way that allows preparation of a brewed chilled drink to be ready in 0.5-1.5 minute and they are not well suitable for professional use, as their often relatively complicated arrangement is cumbersome to regularly clean and/or to use by the consumer.

Devices exist in the art to prepare iced tea at home. Such a device has been described for example in WO2013/011154. This device comprises a receiving means for a starting material and a vessel. The device is designed in such a way that when tea is brewed in the receiving means, it cannot enter the vessel. The receiving means is opened by turning it and the brewed tea runs into the vessel which can contain ice, to cool the tea.

While the machine as described in WO2013/011154 might be advantageous for the consumer at home, it is not for use in a restaurant. The resulting iced tea is not of constant quality, as it depends on decisions of the consumer regarding brewing time. Some customers use a short brewing time, some a long brewing time. This is not desired in a restaurant setting, where an end product of constant quality is expected. Furthermore, the device is relatively complicated and involves many parts. Cleaning the device and rearrange it for a next customer is therefore complicated and time-consuming for the personnel in a restaurant. Also the use of this device is relatively complicated and involves a multi-step process. The consumer would need to carry out several steps and make judgments regarding the state of brewing, and how to open the receiving means to allow exiting of brewed tea into the ice-containing vessel. Especially in a restaurant setting, where personnel are not available to assist in each step in the process for all the consumers, this is not desired. In addition, the entire process of brewing a tea, managing the device and cooling the tea is easily considered too long. A complicated device and a relatively long and complicated process is not desired by a thirsty person who orders a freshly brewed iced tea to relieve her or his thirst, especially at a warm day in summer.

A need exists for a device for preparing freshly brewed chilled beverage, preferably iced tea, said device being straight-forward in use, delivering an infused chilled beverage of reproducible quality, not containing many parts and being easy to clean. The use of it is fast and involves only one step, preferably the cooled beverage being delivered instantly after the start of its preparation. Preferably the device allows the consumer to see the preparation process.

Surprisingly, this aim could be met by a device for preparing a chilled, infused beverage, comprising a brewing chamber (1),

wherein an opening (3) is present in the brewing chamber to allow discharge of water from the brewing chamber, and

wherein the opening (3) allows the brewing chamber (1) when full of water to empty by gravity in a fixed time of between 0.5 and 1.5 minute.

The invention further relates to a method for preparing an chilled, infused beverage, the method comprising the steps of:
a. inserting ice in a collection container,
b. positioning the brewing chamber (1) of the device according to the invention above, on top of or, at least partly, into a collection container,
c. inserting an infusion package containing plant material in the brewing chamber,
d. inserting water in the brewing chamber,
e. allowing the liquid to transfer from the brewing chamber into the collection container,

to result in a chilled, infused beverage.

The invention further relates to the use of a device according to the invention for preparing iced tea.

### DESCRIPTION OF THE DRAWINGS

FIG. 1 shows a cross-section of a device (1) according the invention, comprising a brewing chamber.

FIG. 2 shows a cross-section of a device according to the invention, comprising a brewing chamber and a collection container (2) in the form of a pitcher. Ice (10) is present in the collection container. The brewing chamber (1) is being put into the collection container.

FIG. 3 shows the brewing chamber being in place inside of the collection container. A tea bag (9) is placed inside of the brewing chamber.

FIG. 4 shows the brewing chamber being in place inside of the collection container, a tea bag is located inside of the brewing chamber and water has been added into the brewing container, running freely into the collection container through opening (3).

FIG. 5 shows the device according to the invention, wherein a lid (5) is being located on top of the brewing chamber.

FIG. 6 shows a device according to the invention, wherein the water collects in the collection container, is cooled by the ice cubes, resulting in iced tea.

FIG. 7 show a top view of the device of the invention comprising a brewing chamber and a pitcher, the brewing chamber being located inside of the pitcher and having a lid on top of the brewing chamber. A gap is present in the lid, through which the thread of a tea bag runs.

FIG. 8 shows a graph plotting the A445 versus the time for a brewing process with four types of tea.

FIG. 9a shows a device according to the invention wherein the brewing chamber (1) is located above a collection container (2), which contains ice (10). FIG. 9b shows the corresponding top view showing the opening in the centre (3).

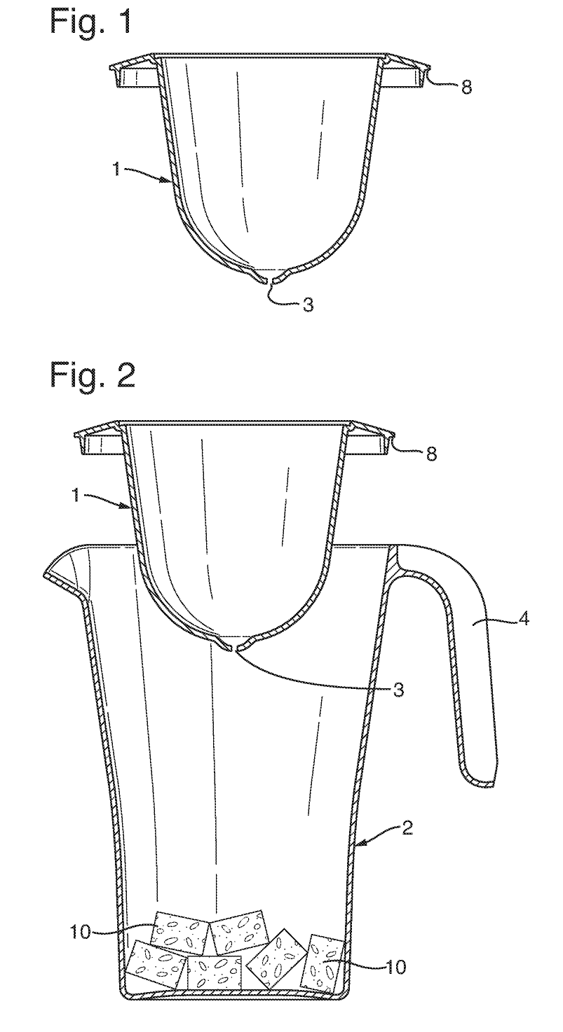

### DETAILED DESCRIPTION OF THE INVENTION

Device

The present invention provides a device for the preparation of a chilled, infused beverage. The chilled beverage is preferably an iced tea. The device comprises a brewing chamber (1) and preferably a collection container (2). From the start of the brewing process, the water from the brewing chamber runs into a collection container. This provides a simple and fast means to provide an infused chilled beverage, with constant quality for each time of preparation.

Brewing Chamber

The device of the present invention comprises a brewing chamber (1). Typically, the device comprises only one element for receiving water, like a brewing chamber, apart from the collection container. The brewing chamber (1) is located above, on top of or inside of a collection container (2), preferably inside of the collection container, or preferably partly inside of the collection container. The collection container is not necessarily part of device, and can for example be a tea pot or a glass or a pitcher. It can be preferred for example, that the bottom of the brewing chamber (1) comprises a profile to allow stable positioning on a collection container. This might be a relief pattern, e.g. comprising concentric circles.

It is preferred, however, that the collection container forms part of the device. To this end, preferably the invention relate to a device further comprising a collection container (2). Preferably, the brewing chamber (1) is located on top of the collection container (2) or inside of the collection container (2), or part of the brewing chamber is located inside of the collection container. The brewing chamber (1) resembles preferably a paraboloid, a tubular shape, a truncated cone shape, or catenoid shape, to provide efficient discharge of the water from the brewing chamber.

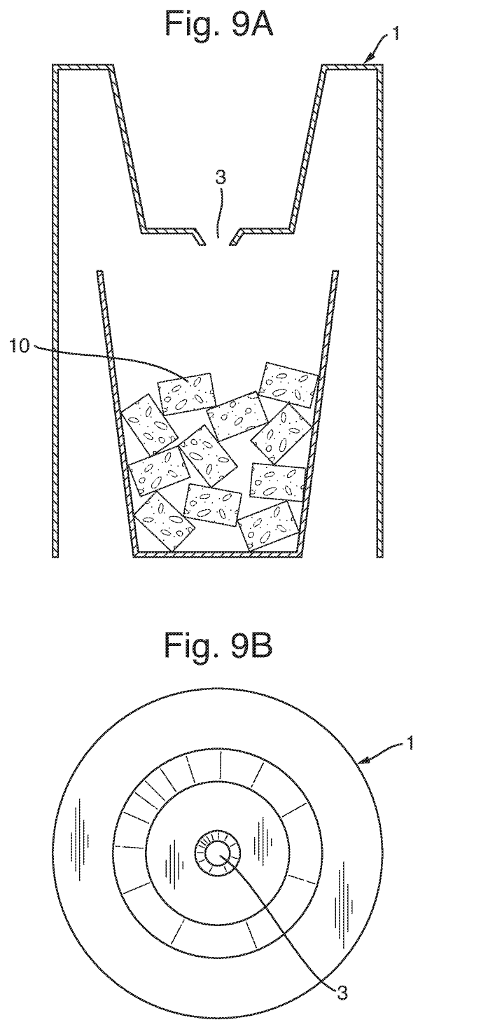

The brewing chamber may be positioned above the collection chamber (see FIG. 9a and its corresponding top view 9b), but is more normally, and most preferably, in contact with the collection container, preferably removable from the collection container, preferably the brewing chamber is removably connected to the collection container. The brewing chamber, preferably via the upper part of the brewing chamber, is preferably removably connected to the upper rim of the collection container (2). As is understood by the skilled person, “removably connected” is not limited to the meaning of a fixed removable connection, but includes the meaning of “in contact with”. For example, preferably the brewing container can rest, e.g. via an annulus (8) protruding from the brewing chamber, preferably from the upper rim of the brewing chamber, on the upper rim of the collection container, for example via an annulus connected to the upper part of the collection container, which annulus is extending inside or outside of the collection container. In this manner the brewing chamber is effectively hanging, in the collection chamber or is supported by it. The device of the invention can comprise connecting means to connect the brewing chamber to the collection container in a fixed removably connected manner. Such a connecting means can comprise for example a click system or a screw thread. Preferably the brewing chamber is removably connected to the collection container wherein the brewing chamber is supported by the collection container and preferably stands on and/or at least part of it hangs in the collection container. Especially in case the brewing chamber is positioned above the collection chamber, the brewing chamber may be supported by a tubular support or by a support like a tripod.

The volume of the brewing chamber is preferably of from 100 to 1500 ml, more preferably of from 200 to 1000 ml, even more preferably of from 200 to 600 ml, most preferably of from 450 to 550 ml.

At the bottom of the brewing chamber an opening (3) is present to allow transfer of liquid from the brewing chamber (1) into the collection container (2). The opening is preferably located at the lowest part of the brewing chamber. This is understood as in the situation when the brewing chamber is in position on a collection container. In case of the preferred essentially paraboloid or essentially catenoid shape of the brewing chamber, the hole is preferably located at the top of the paraboloid or catenoid, which represents the lowest part of the brewing chamber when the brewing chamber is positioned on the collection container.

The shape of the opening is preferably circular. The brewing chamber has a fixed time to empty. A device is preferred wherein the opening (3) allows a brewing chamber (1) full of water to empty into the collection container in a time of between 0.5-1.5 minute. A fixed time to empty guarantees an infused beverage that is standardized in quality and quality is therefore independent of decisions on brewing time. So, the time to empty the brewing chamber cannot be varied, for example by manipulation of the consumer, such as by opening or closing the opening by for example a valve or a switch.

The skilled person will understand that in general the time required for a vessel to empty essentially depends on the amount of liquid, corresponding to the volume of the brewing chamber, on the shape of the brewing chamber and on the size of the opening. Consequently, in the device according to the invention, wherein the desired volume and shape of the brewing chamber can be taken a as a fixed starting point, it is only the hole that determines the flow speed. It is in the skill of the artisan and without any burden to design the diameter of the opening to obtain a time of between 0.5 and 1.5 minutes for emptying the brewing chamber by gravity. Such a diameter can be determined experimentally, but also be calculated by applying laws of physics to determine the flow rate out of the orifice.

The size of the opening (3) typically is fixed. The size is typically not manipulated by a closing or opening valve, e.g. activated by the consumer. The opening is preferably a single opening, preferably with a circular shape. The opening preferably has a total surface area (as measured at the bottom of an opening) of between 3.8 and 66.5 mm², preferably of between 7 and 19.6 mm², preferably of between 9.6 and 15.9 mm², most preferably of between 11.3 and 13.9 mm². The opening, preferably the circular opening, preferably has a diameter, measured at the widest point of the bottom of the opening, of between 2.2 mm and 9.2 mm, preferably of between 3 and 5 mm, more preferably of between 3.5 and 4.5 mm, most preferably of between 3.8 and 4.2 mm. This diameter provides the flow speed of the liquid from the brewing chamber into the collection container, which is considered optimal for the consumer and for the quality of the beverage. It is the diameter of the opening that determines the infusion time. As will be clear for a person skilled in the art, when considering these ranges, a brewing chamber with a high volume normally comprises a relatively large diameter of the opening, whereas a brewing chamber with a relatively small volume normally comprises a relatively small diameter of the opening, to obtain the emptying time of between 0.5 and 1.5 minute. The opening increases commensurate with the volume of the brewing chamber. Preferably the invention relates to a device wherein the volume of the brewing chamber is of between 100 ml and 1.5L and the diameter of the opening is between 2.2 mm and 9.2 mm, preferably of between 3 and 5 mm, more preferably of between 3.5 and 4.5 mm, most preferably of between 3.8 and 4.2 mm. Preferably the volume of the brewing chamber is of from 200 to 1000 ml and the diameter of the opening is of between 3 and 5 mm, even more preferably the volume of the brewing chamber is of from 300 to 600 ml and the diameter of the opening is of between 3.5 and 4.5 mm, most preferably the volume of the brewing chamber is of from 450 to 550 ml and the diameter of the opening is of between 3.8 and 4.2 mm.

Preferably, the transfer of liquid from the brewing chamber into the collection container starts from the start of the brewing process. As will be more set out in detail below, the transfer of liquid from the brewing chamber into the collection container starts upon insertion of water into the brewing chamber (unhampered passage). As the brewing process starts, for example when water is inserted into the brewing chamber, the liquid runs typically freely from the brewing chamber into the collection container. The invention preferably relates to a device wherein the discharge of water from the brewing chamber is unhampered and starts upon addition of water to the brewing chamber. An infusion package is normally present inside the brewing chamber before adding the water. Preferably, the user of the device preferably cannot actively open the opening. Preferably no opening valve is present that can be activated by the user.

The brewing chamber is suitable to receive an infusion package. The infusion package is preferably a bag, a pouch or a capsule. The infusion package preferably comprises material comprising infusible flavor. Preferably the infusion package comprises plant material, preferably tea, comprising infusible flavor. Preferably such plant material comprises tea, and most preferably, the infusion package is a tea pouch, or tea bag or tea capsule. The device of the present invention provides for an efficient process for preparing a chilled infused beverage. It is believed by the applicants that this purpose is most suitably met by using an infusion package such as a pouch containing taste providing material, such as a tea pouch, and not by using loose particles or leaves. Leaves easily cause blockage of the hole (3) at the bottom of the brewing chamber and/or provide an irregular or unpredictable flow of liquid from the brewing chamber into the collection container, even when a sieve is used. Such a sieve would also form an additional compartment of the device, which needs to be cleaned and arranged in place after cleaning. Accordingly, the brewing chamber preferably does not comprise a sieve. Alternatively, the brewing chamber might comprise a sieve. In this case, the sieve is preferably located above the opening (3). In such a device loose tea leaves can be used.

Collection Container

The device of the present invention is normally used with a collection container. The collection container can be a tea pot or a jar or a glass or a pitcher. It is preferred, that the collection container forms part of the device of the invention. Accordingly, preferably the device comprises a collection container (2). Preferably, the device consists of two elements: a brewing chamber and a collection container. Preferably, the brewing chamber (1) is located above, on top of the collection container (2) or at least part of the brewing chamber is located inside of the collection container (2). The collection container collects the liquid from the brewing chamber (1). The collection container preferably comprises a pouring means to facilitate pouring of the beverage, for example from the collection container into a glass. A pouring means is suitably a curvature in the upper rim of the collection container, for example in a shape forming a tetrahedron, preferably a regular tetrahedron. The pouring means can also be a spout. The collection container preferably comprises a grip part (4) to enable easy pouring of the resulting chilled beverage.

The brewing chamber and/or collection container of the invention can be made for example from glass or from plastic. Preferably the brewing chamber and/or collection container are made from copolyester such as for example available under the trade name Eastman Tritan™. This material proved optimal in terms of resistance against heat and cold and tea staining.

The volume of the collection container is preferably from 200 to 3000 ml, more preferably of from 400 to 2000 ml, even more preferably of from 600 to 1200 ml, most preferably of from 900 to 1100 ml. It is preferred that the space of the collection container which is located below the brewing chamber has a volume which is higher than that of the brewing chamber. Hence, preferably, the device of the invention further comprises a collection container, wherein the volume of the space of the collection container which is located below the brewing chamber is higher than the volume of the brewing chamber. Preferably the volume of the space of the collection container which is located below the brewing chamber is from 200 to 3000 ml, more preferably of from 400 to 2000 ml, even more preferably of from 600 to 1200 ml, most preferably of from 900 to 1100 ml. This allows proper emptying of the brewing chamber into the collection container. The shape of the collection container is preferably that of a pitcher with a handgrip.

Lid

It can be desired that the device further comprises a lid (5). The lid preferably covers the upper part of the brewing chamber (2). It can be preferred that the center of the lid (6) comprises an opening, for example a circular opening, through which water can be poured into the brewing chamber. It can be preferred that the lid comprises a gap (7), for example at the outer rim of the lid. Such a gap can be desired to allow steam to prevent building-up of pressure in the brewing chamber as a consequence of the presence of hot water or to prevent formation of a vacuum in the brewing chamber during emptying, which can hamper proper emptying. In case a infusion package is used comprising for example tea wherein the infusion package contains a thread, e.g. with a brand label, the gap in the lid allows that the thread runs through the gap, in this way facilitating proper closure of the lid. An additional advantage which was observed is that the thread guided through the gap in the lid prevents an infusion package (e.g. a tea bag), connected to the thread and present in the brewing chamber, from rotating. In this way formation of a vortex is disturbed, at least to a certain extent.

Formation of a vortex during emptying is not desired, as this can influence the predetermined discharge time, e.g. it easily lengthens the discharge time. Preferably, the device comprises a means to limit vortex formation, such as for example a means to guide or attach a thread of an infusion package, (such as a gap in the lid, if present, or a gap or protrusion in the wall of the brewing chamber or a gap or protrusion in collection chamber or handgrip thereof, if present), protrusions on the inside of the brewing chamber like baffles, a rim on the inside of the brewing chamber, protrusions from the lid, a non-circular hole (3), multiple holes (3), a brewing chamber which is not round, but contains at least one angle in its cross-section, or combinations of these means.

Preferably, the invention relates to a device for preparing a chilled, infused beverage, comprising a brewing chamber (1), wherein an opening (3) is present in the brewing device to allow discharge of water from the brewing chamber, wherein the size of the opening is fixed and wherein the opening (3) allows the brewing chamber (1) when full of water to empty by gravity in a fixed time of between 0.5 and 1.5 minute, wherein the device comprises a collection container (2), wherein the brewing chamber (1) is located on top of the collection container (2) or at least part of the brewing chamber is located inside of the collection container (2), wherein the size of the brewing chamber is of between 200 to 1000 ml and the diameter of the opening (3) is of between 3 and 5 mm,

wherein the volume of the space of the collection container (2) which is located below the brewing chamber (2) is from 400 and 2000 ml,

wherein the collection container comprises a hand grip,

and wherein the device further comprises a lid.

The invention further relates to a device according to the invention, comprising an infusion package, wherein the infusion package comprises fast infusible tea. The invention further relates to a device according to the invention comprising an_infusion package comprising a leaf tea product wherein the leaf tea product has a total soluble solids content of at least 50% by weight. “Total soluble solids” for a leaf tea is known in the art and means water extract as determined by the method set forth in the International Standard ISO 9768:1994(E) entitled “Tea-determination of water extract'. The amount of leaf tea product in the infusion package is preferably from 2 to 9 grams, more preferably from 3 to 9 grams, more preferably of from 3 to 8 grams, even more preferably of from 4 to 8 grams, even more preferably of from 6 to 7 grams. The ratio of leaf tea product (grams) to volume of the brewing chamber (ml) multiplied by 100% is preferably of between 0.4 and 2.5, more preferably of between 0.5 and 2, even more preferably of between 0.6 and 1.

An infusion package is defined as a closed container which comprises at least one filter wall wherein the filter wall is water-permeable but is not permeable to leaf tea.

Examples of infusion packages are tea bags and capsules. Tea bags are typically formed from flexible filter material such as paper, non-woven fabric, woven fabric and the like. Capsules are typically formed from plastic material and/or plastic-metal foil composites.

It is preferred that the shape of the infusion package is the shape of a pyramid. This proved to have excellent infusion characteristics.

Process for Preparing a Chilled Infused Beverage

Method for preparing a chilled beverage, the method comprising the steps of:
a. inserting ice in a collection container,
b. positioning the brewing chamber (1) of the device according to the invention above, on top of or at least partly into a collection container,
c. inserting an infusion package containing plant material in the brewing chamber,
d. inserting water in the brewing chamber,
e. allowing the liquid to transfer from the brewing chamber into the collection container,
to result in a chilled, infused beverage.

Inserting Ice

In step a) ice is inserted in a the collection container. The ice is preferably inserted as ice cubes. Preferably the weight of the ice inserted in the collection container is more than the weight of the water to be inserted in the brewing chamber in step d). Ice is preferably added in weight ratio to the liquid added to the brewing chamber of from 0.5:2 to 2:0.5, more preferably of from 0.75:1.5 to 1.5:0.75, most preferably in a ratio of 1:1.

After inserting ice in the collection container, the brewing chamber is located above, in or on top of a collection container. In this way the liquid in the brewing chamber runs into the collection container by gravity via the opening (3).

Positioning the Brewing Chamber

In step b) the brewing chamber is positioned above, on top of or, at least partly, into the collection container. In case the collection container is not part of the device according to the invention, normally, the brewing chamber is positioned on top of the collection container. When the collection container is part of the device according to the invention the brewing container is preferably positioned at least partly inside of the collection container, more preferably inside of the collection container.

Inserting an Infusion Package

A package containing infusible flavour material is inserted in the brewing chamber in step c) of the process. The package containing plant material preferably is a package which contains tea. The step c) of inserting the infusion package preferably is carried out before inserting the water in the brewing chamber in step d), as results in optimal infusion of the flavours, as the water starts to run immediately into the collection container upon entering the brewing chamber. In case the infusion package containing infusible material is added after the water has been added in the brewing chamber, less flavour will be present in the resulting drink as the time available for the infusion, as determined by the period the water runs from the brewing chamber into the collection container, is shorter. The period the water is in contact with the infusion package is shorter and the volume of water in contact with the infusion package is smaller.

It is preferred that the infusion package comprises a thread. The thread is preferably guided through or attached to a means to guide or attach a thread of an infusion package, (such as a gap in the lid, if present, or a gap or protrusion in the wall of the brewing chamber or a gap or protrusion in the collection chamber or handgrip thereof, if present).

Infusion Package

The process of the invention requires the use of a infusion package (9), preferably comprising infusible flavour ingredients. Preferably the infusion package comprises plant material comprising infusible flavour ingredients. The infusion package preferably comprises plant material selected from tea, rooibos, peppermint, camomile and mixtures thereof, more preferably the infusion package comprises tea. The infusion package can further comprise flavour material, different from tea, rooibos, peppermint, camomile and mixtures thereof, for example fruit flavour or herb flavour. The plant material typically and preferably comprises fast-infusing tea, preferably in an amount of from 2 to 9 grams, preferably of from 3 to 9 grams, preferably of from 4 to 8 grams, more preferably of from 6 to 7 grams per litre of volume of the brewing chamber. Preferably, the infusion package comprises fast-infusing tea. The amount of leaf tea product in the infusion package is preferably from 2 to 9 grams, more preferably from 3 to 9 grams, more preferably of from 3 to 8 grams, even more preferably of from 4 to 8 grams, even more preferably of from 6 to 7 grams. The ratio of leaf tea product (grams) to volume of the brewing chamber (ml) multiplied by 100% is preferably of between 0.4 and 2.5, more preferably of between 0.5 and 2, even more preferably of between 0.6 and 1. Fast-infusing tea is known to the skilled person and is tea which infuses relatively fast, due to for example a treatment of the tea or addition of fast-infusing components, compared to regular (non-treated tea or tea not enriched by fast-infusing solids). Fast-infusion tea has been described for example in WO2004/002235 and WO2012/013519. Preferably the infusible flavour ingredients comprise soluble solids, preferably infusible tea solids, in an amount of at least 50% by weight of the plant material. Preferably the infusion package comprises tea, wherein tea is a leaf tea product wherein the leaf tea product has a total soluble solids content, as defined above, of at least 50% by weight. Preferably, the plant material comprises tea and has a total soluble solids content, as defined above, of at least 50% by weight, based on the weight of the plant material including soluble solids.

In the context of this invention, fast-infusing tea is preferably tea with a size of smaller than 0.5 mm, preferably of between 0.25 and 0.5 mm, or is tea having soluble tea solids, in an amount of at least 50% by weight of the tea material including soluble solids for example by soluble tea solids having been added to the tea leaves. Most preferably, fast-infusing tea is tea having soluble tea solids, in an amount of at least 50% by weight of the tea including soluble tea solids by soluble tea solids having been added to the tea leaves.

Preferably the fast-infusing tea is tea that that provides an absorption level at 445 nm (A₄₄₅) of the infusion liquid (water infused with soluble tea solids) after a brewing period of 45 seconds of between 1 and 1.6, more preferably of between 1.1 and 1.5, even more preferably of between 1.2 and 1.4. The A445 nm is measured according to the method described in Example 2, and is well known to a person in the art, as an unsigned logarithmic ratio between the radiation falling upon a material and the radiation transmitted through a material. It is normally expressed in A, as unit for ‘absorbance’.

It is preferred that the fast-infusing tea is a tea that provides a percentage of soluble tea solids in the infusion liquid after 45 seconds of brewing of higher than 23, preferably higher than 24, most preferably higher than 27, (wt % based on the weight of the tea including soluble tea solids). The level is preferably of between 23 and 40, more preferably of between 24 and 35, even more preferably of between 27 and 33 (wt % based on the weight of the tea including soluble tea solids). The level of soluble solid tea matter is calculated according to the method provided in Example 3.

Most preferably, the fast infusing tea is a tea that has a total soluble solids content, as defined above, of at least 50% by weight, based on the weight of the plant material including soluble tea solids, wherein the tea provides an absorption level at 445 nm (A₄₄₅) of the infusion liquid after a brewing period of 45 seconds of between 1 and 1.6, more preferably of between 1.1 and 1.5, even more preferably of between 1.2 and 1.4, and wherein the tea provides a percentage of soluble tea solids in the infusion liquid after 45 seconds of brewing of between 23 and 40, more preferably of between 24 and 35, evenmore preferably of between 27 and 33 (wt % based on the weight of the tea including soluble tea solids).

Inserting Water in the Brewing Chamber

In step d) water is inserted in the brewing chamber. The amount of liquid is preferably equal to the volume of the brewing chamber. The water preferably has a temperature of between 60 and 100° C., preferably of between 80 and 100° C., most preferably of between 90 and 100° C. Water is inserted in the brewing chamber to result in an infused liquid. Preferably the resulting infused liquid is tea. Water is preferably added in an amount that the ratio of leaf tea product (grams) to volume of added water (ml) multiplied by 100% is preferably of between 0.4 and 2.5, more preferably of between 0.5 and 2, even more preferably of between 0.6 and 1.

Allowing the Water to Transfer from the Brewing Chamber into the Collection Chamber.

In step e) liquid is allowed to run form the brewing chamber into the collection container. It preferably runs freely, without being hampered by for example a valve.

In a preferred scenario, ice is put in the collection container, and the brewing chamber is put above, on top of or into the collection container. An infusion package comprising infusible flavour, preferably a tea bag, is brought into the brewing chamber. Then water is added into the brewing chamber. Immediately upon addition of the water, the infusion process of flavours into the water starts in the brewing chamber. The water, comprising flavour, runs via the opening in the bottom of the brewing chamber into the collection container, where it flows over the ice. A chilled infused beverage results.

So, in normal use, the water inserted into the brewing chamber starts to run into the collection container via the opening before or immediately from the start of the brewing process, preferably in a time of between 10 seconds before the start of the brewing process to 5 seconds after the start of the brewing process, most preferably between 1 second before the start of the brewing process to 2 seconds after the start of the brewing process. It is clear for the skilled person that from the start of the brewing process onwards, the water will comprise material originating from the infusion package which has been infused for example from the material in the infusion package.

The invention preferably relates to a chilled infused beverage, preferably an iced tea, prepared according to the process of the invention.

Use

In a further aspect, the invention relates to the use of a device according to the invention for preparing a chilled infused beverage, preferably iced tea, preferably in a time of between 0.5 and 1.5 minutes.

The invention is now exemplified by the following now-limiting example.

### EXAMPLE 1

A device was used according to FIG. 2, comprising a brewing chamber (volume 500 ml), collection container (volume 2000 ml, ca 1500 ml space below the brewing chamber) in the form of a pitcher and a lid.

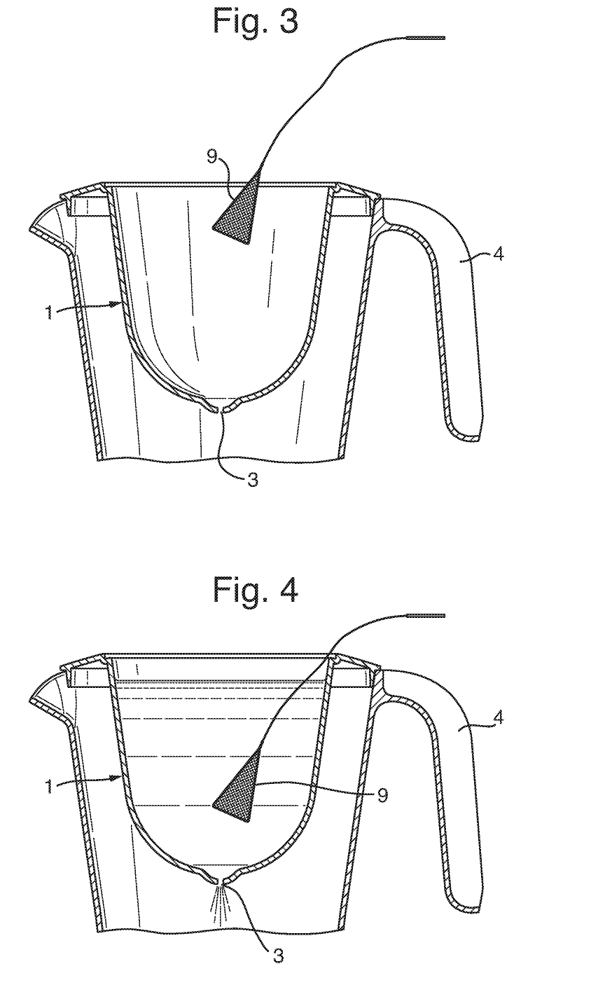

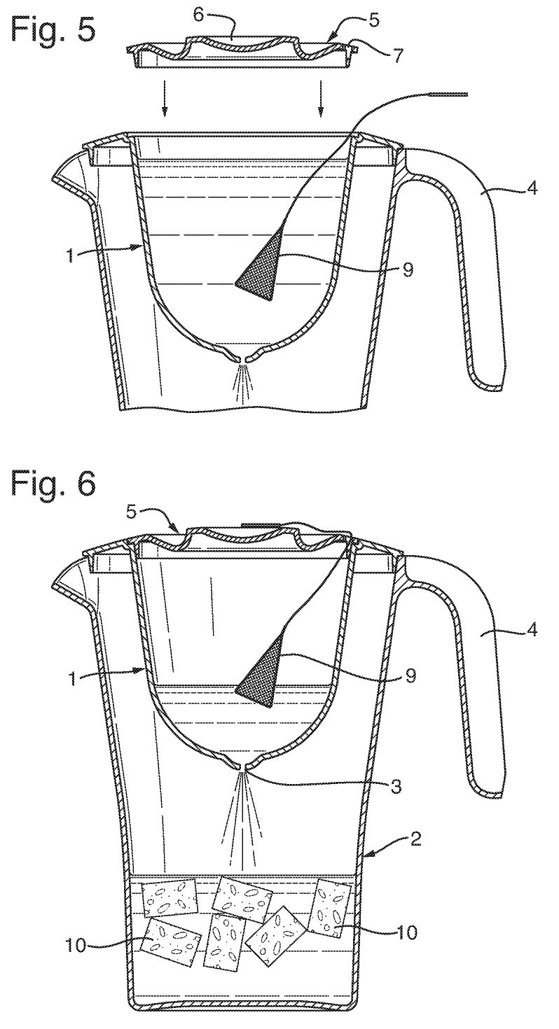

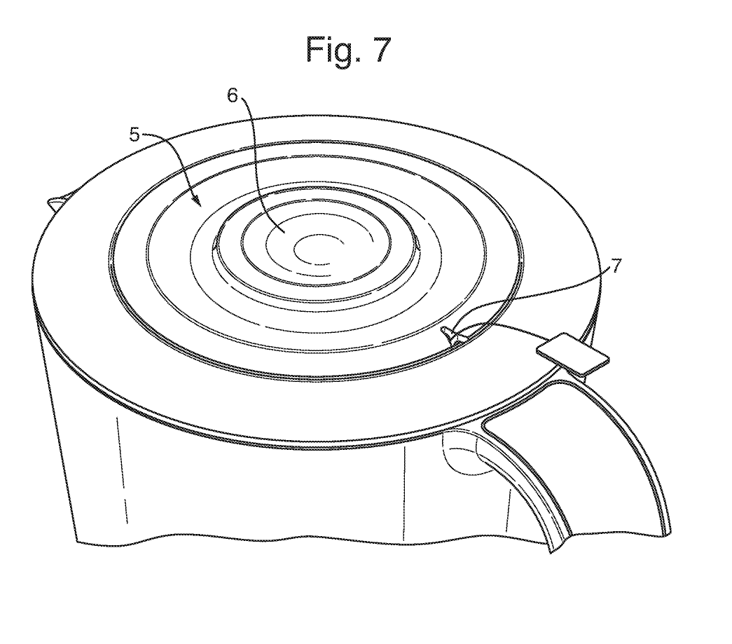

500 grams of ice cubes were put in the collection container. Then the brewing chamber was positioned inside the collection container, whereby the brewing chamber rested on the rim of the collection container, see FIG. 2. A tea bag was inserted in the brewing container, see FIG. 3, wherein the tea bag contained 3.2 grams of fast-infusible tea. The fast infusible tea was prepared as described in WO2012/013519 and contained at least 50% by weight total soluble solids as determined by the method set forth in the International Standard ISO 9768:1994(E). The total amount of infusible solids was 0.85 g in (a total weight of) 1.4 grams of dry fast infusing leaf tea. 500 ml of boiling water was poured into the brewing chamber. Immediately the infusion process started. Immediately upon entering the brewing chamber, and after the start of the brewing process, the liquid started to run through the opening (3) at the bottom of the brewing chamber into the collection container, see FIGS. 4 and 6. After pouring the boiling water into the brewing chamber, the lid was put on the brewing chamber, wherein the thread of the tea bag was put through a gap in the lid. It took one minute until all the water had run from the brewing chamber into the collection container. During this minute, the infusion process took place in the brewing chamber, resulting in infused tea liquid. In the collection container the tea mixed with the ice cubes, resulting in iced tea.

### EXAMPLE 2

A comparative test was carried wherein different types of tea were compared with regard to their respective infusion rates. The absorption A445, as a measure for infusion, was measured over time. This test illustrated that fast-infusing tea proves optimal in the use of the present invention.

Four samples of the same type of black tea were used:

1. Fine sieved (0.25-0.5 mm mesh size)

2. Smaller sized tea (0.5-0.71 mm mesh size),

3. Higher sized tea (0.71-1.25 mm mesh size),

4. Tea with added tea solids, see Example 1, (0.71-1.18 mm mesh size).

Procedure to Measure Absorption

3.2 grams of tea was packaged in a pyramid teabag from teabag paper with corner to corner distances of 65 mm, as known in the art. The teabags were automatically dunked once a second for 3 minutes in 250 ml freshly boiled deionised water in a vessel. The teabag is attached by one corner to the dunker. Tests were carried out 4 times and an average absorption value was calculated for each time point.

The vessel is connected to a spectrophotometer via a tube and a pump device provides a flow rate of 60 ml/min. The progress in infusion is monitored by automatic recording of the absorption values at 445 nm (time drive mode, 1 measurement per second). A lag time of 5-7 seconds may be present in the measurement time, reflecting the time the water that was present in the tubing is replaced by infused water. This lag-time is not construed as part of the infusion time.

Results

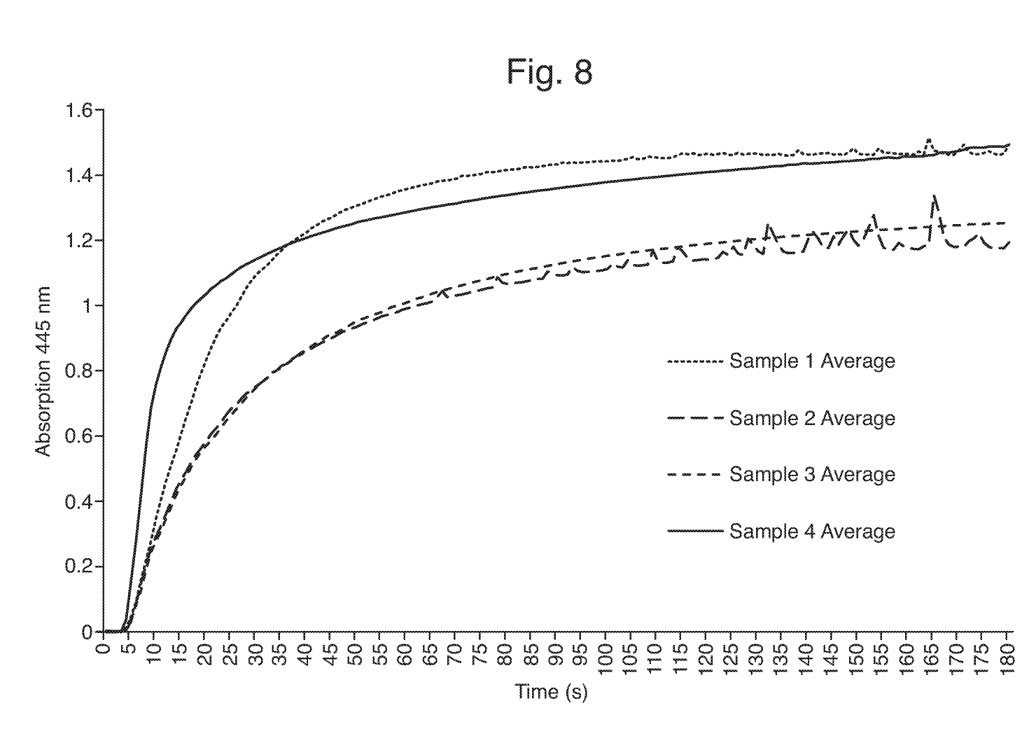

The results are plotted in the FIG. 8. It can be noted in FIG. 8 that all four samples start their infusion after 5 seconds, followed by a steep increase in absorption at 445 nm, reflecting the progress in infusion, and levelling off at about 90 seconds. Samples 2 and 3, having a leave size of between 0.5 and 1.25 mm (mesh size), showed a similar pattern. Their rate of infusion is considered too slow for the purposes of this invention, as insufficient infusion has taken place during the time period the brewing chamber empties. Samples 1 and 4, reflecting the infusion behaviour of fine leaves (0.25-0.5 mm mesh) and the general sized leaves with added solids, respectively, showed a comparable infusion pattern. This holds both for the start of infusion which is faster than the other samples, and for the final absorption, observed after 3 minutes, which is comparable and both higher than the values reached by the samples 2 and 3. Samples 3 and 4 show similar particle size. Note that sample 4 shows a faster start of the infusion (steeper curve) than sample 1, rendering the area under the curve for the first 45 seconds of infusion higher for sample 4, and thereby sample 4 the most preferred choice for application in the present invention. Sample 4 provides in the first 45 seconds, the strongest (most infused) tea. During the process of infusion, sample 1 infuses more than sample 4, but the later time periods are less relevant for the present invention, as the brewing chamber might be emptied by then.

Samples 1 and 4 are suitable for use in the present invention, with sample 4 being most preferred. They show a level of absorption after 45 seconds (50 seconds minus 5 seconds lag time) between 1.2 and 1.4.

### EXAMPLE 3

A comparative example shows that the amount of tea solids infused over time in water is different for different types of tea. A minimum infusion rate is required for the present invention.

The four samples as described in Example 2 were compared for their infusion of solid tea matter over time.

Procedure to Measure Infused Solid Matter

3.2 grams of tea was packaged in a pyramid teabag from teabag paper with corner to corner distances of 65 mm, as known in the art. The teabags were continuously infused in a vessel with 250 millilitres of just boiled deionised water (T>90° C.), with gentle stirring, for various time periods. After a required time period of infusion, the tea bag is not squeezed on removal of the vessel. An aliquot of 50 mls is taken from each infusion and dried down overnight at 105° C. in a pre-weighted foil dish then allowed to cool in a desiccator and reweighed.

To calculate the solubles of the tea, the difference in the tray weights is taken and then multiplied by 5, then divided by 3.2, then multiplied by 100. This gives the percentage of the tea solubilised for each sample at each time point.

Result

The table below indicates the values for sample 3 and sample 4 for several time points between 5 and 60 seconds, and the values observed for 45 seconds for samples 2 and 1.

| Tea | Infusion Time (s) | Average % solids in cup |
|---|---|---|
| Sample 3 | 5 | 8.2 |
| Sample 3 | 10 | 11.9 |
| Sample 3 | 15 | 14.4 |
| Sample 3 | 20 | 15.9 |
| Sample 3 | 30 | 18.8 |
| Sample 3 | 45 | 22.3 |
| Sample 3 | 60 | 26.5 |
| Sample 4 | 5 | 17.9 |
| Sample 4 | 10 | 22.4 |
| Sample 4 | 15 | 25.4 |
| Sample 4 | 20 | 27.3 |
| Sample 4 | 30 | 29.3 |
| Sample 4 | 45 | 31.2 |
| Sample 4 | 60 | 35.9 |
| Sample 2 | 45 | 20.3 |
| Sample 1 | 45 | 24.9 |

The table shows that for the infusion time available in the apparatus of the present invention, it was sample 4 that provided the highest amount of infused tea solids after 45 seconds of infusion time. Teas of samples 3 and 4 have almost the same particle size. Sample 1 also showed levels that prove acceptable in the context of the present invention. Samples 2 and 3 are considered as not suitable, as the level of tea solids after 45 seconds is considered insufficient to provide acceptable product quality of iced tea.

1. Device for preparing a chilled, infused beverage, comprising a brewing chamber (1),
wherein an opening (3) is present in the brewing chamber to allow discharge of water from the brewing chamber, characterised in that the opening (3) allows the brewing chamber (1),
when full of water to empty by gravity in a fixed time of between 0.5 and 1.5 minute, wherein the device allows unhampered discharge of water from the brewing chamber that starts upon addition of water to the brewing chamber,
wherein the device contains an infusion package, wherein the infusion package comprises fast infusing tea,
wherein the fast infusing tea is tea with a size of smaller than 0.5 mm, or is tea having soluble tea solids, in an amount of at least 50% by weight of the tea including soluble tea solids.

2. Device according to claim 1, wherein the fast-infusing tea is tea that provides an absorption at 445 nm of infusion liquid after a brewing period of 45 seconds of between 1 and 1.6

3. Device according to claim 1, wherein the fast-infusing tea is tea that provides a percentage of soluble tea solids in the infusion liquid after a brewing period of 45 seconds of higher than 23, based on the weight of the tea including soluble tea solids.

4. (canceled)

5. Device according to claim 1, wherein the fast infusing tea is a tea that has a total soluble solids content of at least 50% by weight, based on the weight of the tea including soluble tea solids, wherein the tea provides an absorption level at 445 nm of the infusion liquid after a brewing period of 45 seconds of between 1 and 1.6, and wherein the tea provides a percentage of soluble tea solids in the infusion liquid after 45 seconds of brewing of between 23 and 40, based on the weight of the tea including soluble tea solids.

6. Device according to claim 1, wherein the size of the opening (3) is fixed.

7. (canceled)

8. Device according to claim 1, wherein the volume of the brewing chamber (1) is of between 100 ml and 1.5 L and the diameter of the opening (3) is of between 2.2 and 9.2 mm, preferably wherein the volume of the brewing chamber (1) is of between 200 and 1000 ml and the diameter of the opening (3) is of between 3 and 5 mm.

9. Device according to claim 1, further comprising a collection container (2), wherein the brewing chamber is located above, on top of the collection container or at least partly inside of the collection container.

10. Device according to claim 9, wherein the collection container is removably connected to the brewing chamber.

11. Device according to claim 9, wherein the collection container comprises a hand grip and a pouring means.

12. Method for preparing an chilled, infused beverage, the method comprising the steps of:
a. inserting ice in a collection container,
b. positioning a brewing chamber (1) above, on top of or at least partly into a collection container, wherein an opening (3) is present in the brewing chamber to allow discharge of water from the brewing chamber,
c. inserting water in the brewing chamber,
d. allowing the liquid to transfer from the brewing chamber into the collection container,
to result in a chilled infused beverage, characterised in that the opening (3) allows the brewing chamber (1) when full of water to empty by gravity in a fixed time of between 0.5 and 1.5 minute, wherein the device allows unhampered discharge of water from the brewing chamber that starts upon addition of water to the brewing chamber, and in that the method further comprises the step of inserting an infusion package containing plant material in the brewing chamber, wherein the infusing package comprises fast infusing tea, wherein the fast infusing tea is tea with a size of smaller than 0.5 mm, or is tea having soluble tea solids, in an amount of at least 50% by weight of the tea including soluble tea solids.

13. Method according to claim 12, wherein the water inserted into the brewing chamber starts to run into the collection container via the opening (3) before or immediately from the start of the brewing process, preferably in a time of between 10 seconds before the start of the brewing process to 5 seconds after the start of the brewing process.

14. Method according to claim 12, wherein the water has a temperature of between 60 and 100° C., preferably of between 80 and 100° C.

15. Use of a device according to claim 1 for preparing iced tea.
